(19) United States
(12) Patent Application Publication
(10) Pub. No.: US 2007/0152422 A1
(43) Pub. Date: Jul. 5, 2007

(54) Pivotable device for bicycles or tricycles

(76) Inventor: Stephanie Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,878

(22) Filed: Dec. 30, 2005

(51) Int. Cl. B62K 21/00

(52) U.S. Cl. 280/275

(57) ABSTRACT

A bicycle or a tricycle includes a front portion and a rear portion which is pivotably connected to the front portion. A connection protrusion extends from a distal end of the down tube of the front portion and rotatably connected to a first bracket on an end of the rear portion so that the front portion is pivotable relative to the rear portion. The front portion may tilt an angle while the rear portion maintains the upright status.

### FIELD OF THE INVENTION

The present invention relates to a pivotable device for connecting a front portion and a rear portion of a bicycle or a tricycle so as to keep balance for the tricycle.

### BACKGROUND OF THE INVENTION

A conventional tricycle generally includes a frame with a front wheel and two rear wheels which are connected by a shaft and a differential which allows the two rear wheels to operate at different speed when the tricycle turns. The distance between the two rear wheels has to be large enough for the installation of the differential so that the conventional tricycle is bulky and expensive. When the tricycle turns, the whole frame of the tricycle is an integral frame so that it cannot be deformed, the tricycle has to turn at relative low speed to keep the two rear wheels to be in contact with the ground. If the speed is too high, the tricycle cannot maintain its balance when turning and the tricycle might fall side way.

The present invention intends to provide a pivotably device for connecting the rear portion to the front portion of a bicycle or a tricycle and the rear portion maintains its balance when the front portion turns.

### SUMMARY OF THE INVENTION

The present invention relates to a bicycle or a tricycle which comprises a frame including a front portion and a rear portion which is pivotably connected to the front portion. The front portion includes a head tube with a front fork connected thereto. A front wheel is connected to the front fork. A handlebar assembly is connected to the head tube so as to operate the front fork and the front wheel. A down tube is connected to the head tube and a seat is connected to the down tube. A connection protrusion extends from a distal end of the down tube.

The rear portion includes a main beam and a crank-peal assembly is connected to a bottom bracket on a first end of the rear portion. At least one rear wheel is connected to a second end of the main beam. A first bracket is connected to the first end of the rear portion and the connection protrusion rotatably extends through the first bracket so that the front portion is rotatable relative to the rear portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a tricycle of the present invention;

FIG. 2 is an exploded view to show the tricycle of the present invention;

FIG. 3 is a cross sectional view to show the connection of the connection protrusion and the first bracket on the rear portion of the tricycle, and the connection of the plate on the front portion and the second bracket of the rear portion;

FIG. 4 shows that the front portion is pivotable relative to the rear portion, and

FIG. 5 is an end view to show the plate on the down tube of the front portion and the second bracket of the rear portion.

### DETAILED DESCRIPTION OF THE PREFERRED EMBODIMENT

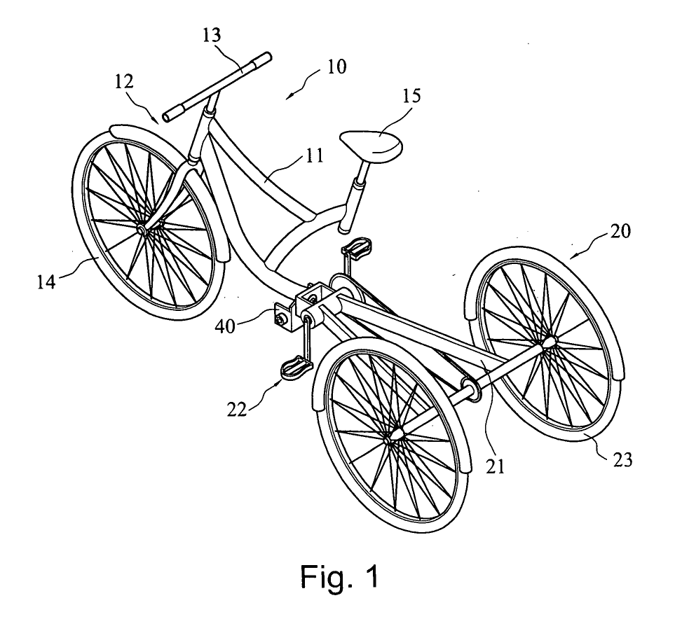

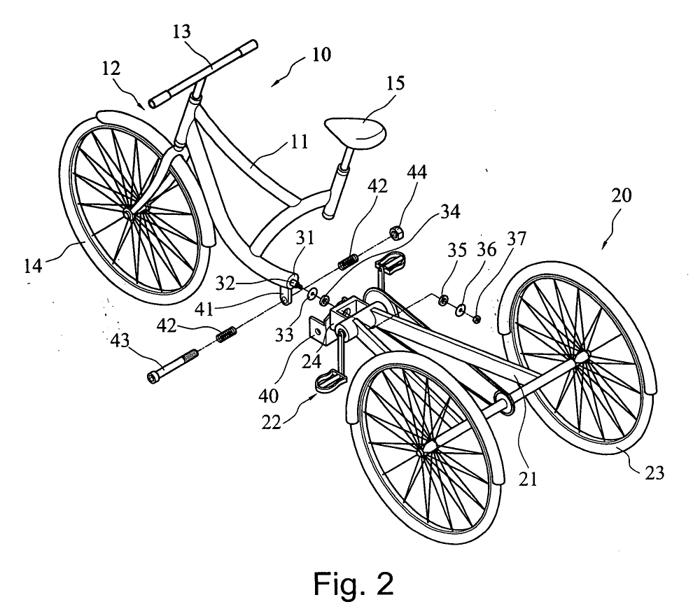

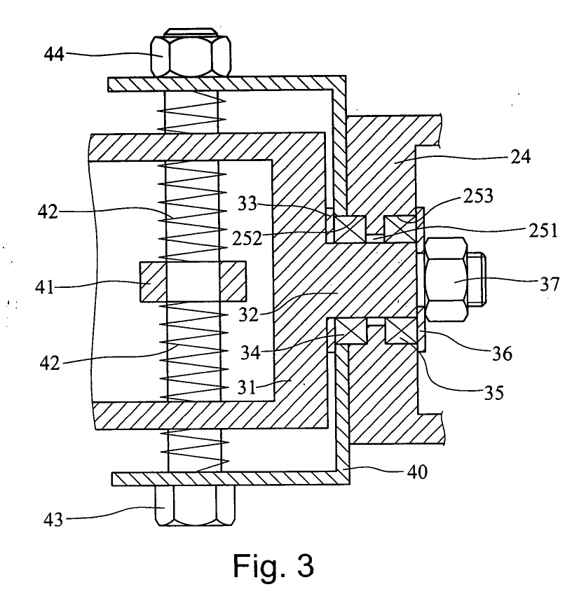

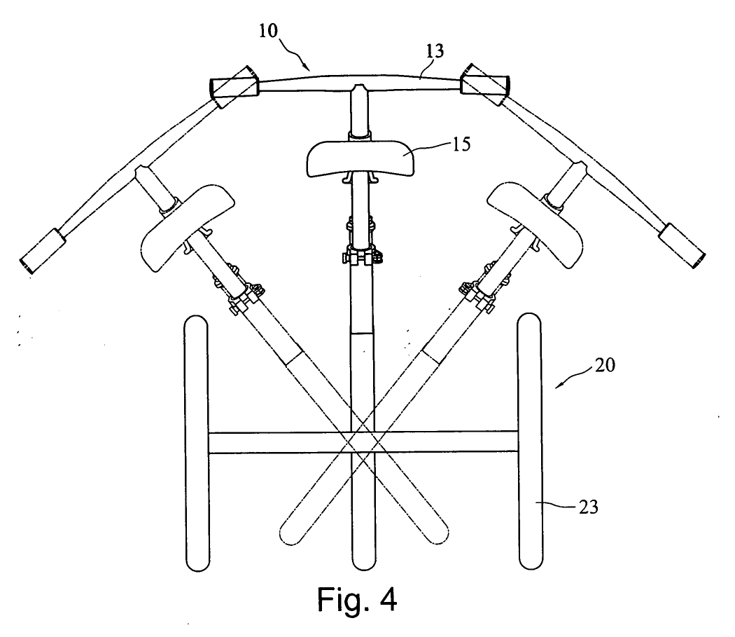

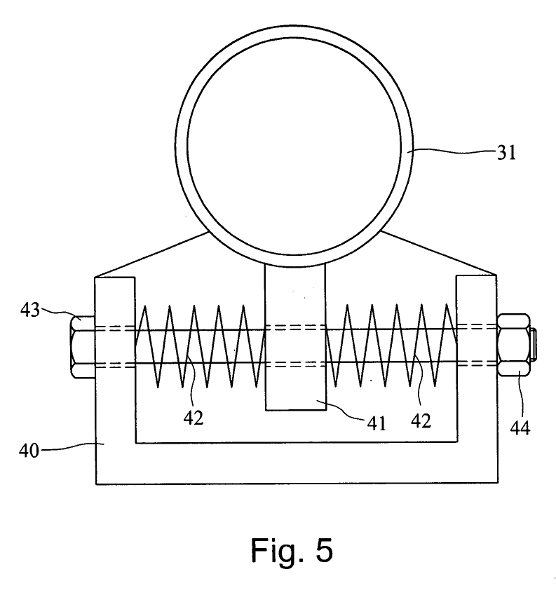

Referring to FIGS. 1 to 5, the tricycle of the present invention comprises a frame 10 including a front portion and a rear portion which is pivotably connected to the front portion by a pivotable device. The front portion includes a head tube 12 with a front fork connected thereto and a front wheel 14 is connected to the front fork. A handlebar assembly 13 is connected to a steer tube (not shown) on the front fork and is rotatably connected to the head tube 12 so as to operate the front fork and the front wheel 14. A down tube 31 and a top tube 11 are connected to the head tube 12 and a seat 15 is connected to the down tube 11. A connection protrusion 32 extends from a distal end of the down tube 31.

The rear portion includes a main beam 21 and a crank-pedal assembly 22 is connected to a bottom bracket on a first end of the rear portion. An axle is connected to a second end of the main beam 21 and two rear wheels 23 are connected to two ends of the axle. A sprocket is connected to an end of the bottom bracket and a gear is connected to the axle, a chain is connected between the sprocket and the gear, so that when operating the crank-pedal assembly 22, the tricycle moves by the rotation of the rear wheels 23.

A first bracket 24 is connected to the first end of the rear portion and has a through hole 251 defined therethrough, two recesses 252 and 253 are defined in two opposite sides of the first bracket 24 and share a common axis of the through hole 251. Two bearings 34, 35 are respectively engaged with the two recesses 252, 253 and the connection protrusion 32 extends through the two bearings 34, 35 and the through hole 251 and are fixedly position by being connected with a nut 37. A first washer 33 is mounted to the connection protrusion 32 and located between the distal end of the down tube 31 and the first bracket 24. A second washer 36 is mounted to the connection protrusion 32 and located between the nut 37 and the first bracket 24.

A second bracket 40 is connected to the first bracket 24 and the distal end of the down tube 31 is located between two side wings of the second bracket 40. A plate 41 extends radially from the down tube 31 and a bolt 43 extends through the two side wings of the second bracket 40 and the down tribe 31 and the plate 41 and is connected with a nut 44. Two springs 42 are mounted to the bolt 43 and the plate 41 is located between the two springs 42, the two springs 42 are biased between the insides of the down tube 31 and the plate 41.

The front portion of the tricycle can be pivoted about an axis of the connection protrusion 32 relative to the rear portion so that when the tricycle turns, the rider can operate the front portion to tilt an angle relative to the rear portion while the two rear wheels 23 are still in contact with the ground. Besides, when turning, the plate 41 push one of the two springs 42 and the other spring 42 is extended. By the two springs 42 the rider cannot tilt the front portion of the tricycle too much so as to prevent falling when turning.

It is noted that the pivotable device can be used to different types of bicycles or tricycles or even the motor-powered bicycles or tricycles.

While we have shown and described the embodiment in accordance with the present invention, it should be clear to those skilled in the art that further embodiments may be made without departing from the scope of the present invention.

What is claimed is:

1. A bicycle or a tricycle comprising:
a frame including a front portion and a rear portion, the front portion including a head tube with a front fork connected thereto, a front wheel connected to the front fork, a handlebar assembly connected to the head tube so as to operate the front fork and the front wheel, a down tube connected to the head tube and a seat connected to the down tube, a connection protrusion extending from a distal end of the down tube, and
the rear portion including a main beam and a crank-pedal assembly connected to a bottom bracket on a first end of the rear portion, at least one rear wheel connected to the main beam, a first bracket connected to the first end of the rear portion and the connection protrusion rotatably extending through the first bracket so that the front portion is rotatable relative to the rear portion.

2. The bicycle or a tricycle as claimed in claim 1, wherein the first bracket has a through hole and two recesses are defined in two opposite sides of the first bracket and share a common axis of the through hole, two bearings are respectively engaged with the two recesses and the connection protrusion extends through the two bearings and the through hole and are fixedly position by being connected with a nut.

3. The bicycle or a tricycle as claimed in claim 1, wherein a second bracket is connected to the first bracket and a distal end of the down tube is located between two side wings of the second bracket, a plate extends radially from the down tube and a bolt extends through the two side wings of the second bracket and the down tube and the plate and is connected with a nut, two springs are mounted to the bolt and the plate is located between the two springs, the two springs are biased between the insides of the down tube and the plate.
